(19) United States
(12) Patent Application Publication
(10) Pub. No.: US 2005/0261989 A1
(43) Pub. Date: Nov. 24, 2005

(54) Apparatus and method for facilitating a search for gem settings

(76) Inventors: Mark Vadon, Seattle, WA (US); Alexander W. Berg, Seattle, WA (US)

Correspondence Address: COOLEY GODWARD, LLP, 3000 EL CAMINO REAL, 5 PALO ALTO SQUARE, PALO ALTO, CA, 94306, US

(21) Appl. No.: 11/101,159

(22) Filed: Apr. 6, 2005

Related U.S. Application Data
(60) Provisional application No. 60/560,181, filed on Apr. 6, 2004.

(51) Int. Cl. G06F 17/60

(52) U.S. Cl. 705/27

(57) ABSTRACT

Apparatus and method for facilitating a search for gem settings are described. In one embodiment, a computer-readable medium includes a gem search module to facilitate a search for a gem to be included in a jewelry item. The computer-readable medium also includes a gem setting search module to facilitate a search for a gem setting to be included in the jewelry item, and the gem setting search module is configured to provide a visual representation of the jewelry item as being worn.

### CROSS-REFERENCE TO RELATED APPLICATION

This application claims the benefit of U.S. Provisional Application Ser. No. 60/560,181, filed on Apr. 6, 2004, the disclosure of which is incorporated herein by reference in its entirety.

### BRIEF DESCRIPTION OF THE INVENTION

The invention relates generally to gem settings. More particularly, the invention relates to facilitating a search for gem settings to be included in various jewelry items.

### BACKGROUND OF THE INVENTION

The Internet is a large collection of computers operated using a client-server computer network model. In a client-server computer network, a client computer requests information from a server computer. In response, the server computer provides the requested information to the client computer. In some instances, the server computer can be operated as a web site and can provide the requested information in the form of web pages. Server computers are often operated by large organizations, such as commercial organizations, governmental units, and educational organizations, while client computers are often operated by individuals.

With the increasing popularity of the Internet, commercial organizations have attempted to set up web sites for marketing and selling products and services. By accessing such web sites, consumers can view information regarding various products and services and can place purchase orders for particular products and services.

To exploit the capabilities and wide reach of the Internet, it is desirable to set up a web site for marketing and selling gems and gem settings. A gem refers to a precious or semi-precious material that can be used for ornamental purposes. In some instances, a gem can be cut and polished into a desired shape. Examples of gems include diamonds, pearls, rubies, sapphires, and so forth. A gem can be used as a stand-alone item or along with a gem setting in a jewelry item. A gem setting refers to a structure that can support a gem in a jewelry item. In some instances, a gem setting can be used as a stand-alone item for ornamental purposes. Examples of gem settings include chains, ring bands, earring bands, and so forth.

Previous attempts to market and sell products and services using the Internet have often been unsuccessful. While this lack of success has resulted from a number of factors, difficulty of use and lack of interactivity of a web site were sometimes key factors. In the case of marketing and selling gems and gem settings, web site features that enhance consumer experience can be particularly important, since consumers can be particularly selective when purchasing gems and gem settings. In particular, it would be desirable to include web site features that facilitate a search for gem settings using search criteria that are intuitively meaningful to a user. In addition, it would be desirable to include web site features that enhance interactivity based on selecting particular results of a search or based on adjusting search criteria.

It is against this background that a need arose to develop the apparatus and method described herein.

### SUMMARY OF THE INVENTION

In one aspect, the invention relates to a computer-readable medium. In one embodiment, the computer-readable medium includes a gem search module to facilitate a search for a gem to be included in a jewelry item. The gem search module is configured to provide a first user-interface element representing a first set of values of a gem attribute. The gem search module is configured to receive a selection of a first value from the first set of values and to identify the gem as being associated with the first value. The computer-readable medium also includes a gem setting search module to facilitate a search for a gem setting to be included in the jewelry item. The gem setting search module is configured to provide a second user-interface element representing a second set of values of a gem setting attribute. The gem setting search module is configured to receive a selection of a second value from the second set of values and to identify the gem setting as being associated with the second value. The gem setting search module is configured to provide a visual representation of the jewelry item as being worn.

In another embodiment, the computer-readable medium includes executable instructions to facilitate creation of a first search query based on a first value of a gem setting attribute. The computer-readable medium also includes executable instructions to identify a first set of gem settings as being responsive to the first search query. The computer-readable medium further includes executable instructions to, in response to a selection of a first gem setting from the first set of gem settings, provide a first visual representation of the first gem setting as being worn.

In another aspect, the invention relates to a computer-implemented method of facilitating a search for gem settings. In one embodiment, the computer-implemented method includes identifying a first set of gem settings as being associated with a first value of a gem setting attribute. The computer-implemented method also includes, in response to a selection of a first gem setting from the first set of gem settings, providing a combined image of the first gem setting and a body part.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer network that can be operated in accordance with an embodiment of the invention.

FIG. 2 illustrates a flow chart for facilitating a search for gem settings, according to an embodiment of the invention.

FIG. 3, FIG. 4, FIG. 5, and FIG. 6 illustrate examples of user-interface screens that can be provided by a gem search module, according to an embodiment of the invention.

FIG. 7, FIG. 8, FIG. 9, FIG. 10, and FIG. 11 illustrate examples of user-interface screens that can be provided by a gem setting search module, according to an embodiment of the invention.

FIG. 12 illustrates an example of a user-interface screen that can be provided by a purchase order module, according to an embodiment of the invention.

### DETAILED DESCRIPTION

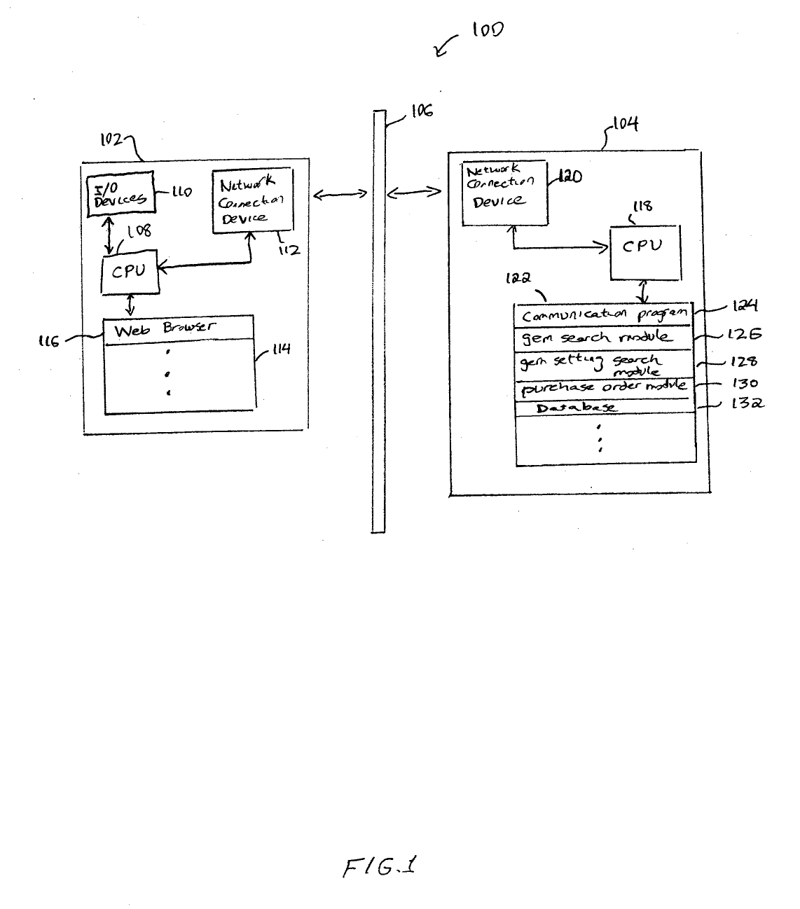

FIG. 1 illustrates a computer network 100 that can be operated in accordance with an embodiment of the invention. In the illustrated embodiment, the computer network 100 is a client-server computer network that includes at least one client computer 102 and at least one server computer 104. The client computer 102 and the server computer 104 are connected by a transmission channel 106, which can be any wire or wireless transmission channel.

The client computer 102 includes conventional client computer components, including a Central Processing Unit (“CPU”) 108 that is connected to a set of input/output devices 110 (e.g., a keyboard, a mouse, a video monitor, a printer, a speaker, and so forth), a network connection device 112, and a memory 114. The memory 114 stores a number of computer programs, including a web browser 116. The web browser 116 is configured to establish conventional network communications with the server computer 104 via the network connection device 112. In addition, the web browser 116 is configured to visually present information received from the server computer 104. In the illustrated embodiment, the client computer 102 can be operated by a user who desires to obtain information regarding various gems and gem settings. Based on such information, the user may desire to purchase a jewelry item that includes a particular gem and a particular gem setting. In some instances, the user may desire to purchase a particular gem or a particular gem setting as a stand-alone item.

The server computer 104 includes conventional server computer components, including a CPU 118 that is connected to a network connection device 120 and a memory 122. The memory 122 stores a number of computer programs, including a communication program 124. The communication program 124 is configured to establish conventional network communications with the client computer 102 via the network connection device 120.

In the illustrated embodiment, the memory 122 also stores a set of computer programs that implement the operations described herein. In particular, the memory 122 stores a gem search module 126, a gem setting search module 128, and a purchase order module 130. As further described below, the various modules 126, 128, and 130 can operate to facilitate a search for gems and gem settings as well as to facilitate purchase of a jewelry item that includes a particular gem and a particular gem setting. Referring to FIG. 1, the various modules 126, 128, and 130 can operate in conjunction with a database 132, which can organize information associated with various gems, gem settings, and jewelry items. In addition, the database 132 can organize sales information provided in connection with various purchase orders. The database 132 can be implemented as, for example, a relational database in which information can be organized using a set of tables.

With reference to FIG. 1, the gem search module 126 is configured to facilitate a search for gems. In particular, the gem search module 126 is used to search for a gem to be included in a jewelry item. For example, the gem search module 126 can be used to search for a diamond to be included in a bracelet, a brooch, an earring, a pendant, a ring, or any other ornamental object. In some instances, the gem search module 126 can be used to search for a gem to be purchased as a stand-alone item, such as a loose diamond.

In the illustrated embodiment, the gem search module 126 provides a first set of user-interface elements to facilitate a search for gems. Examples of user-interface elements include check boxes, icons, numeric or text entry fields, pop-up lists or menus, pull-down lists or menus, push buttons, radio buttons, sliding display elements, scrolling lists, spin boxes, tabs, and so forth. The gem search module 126 provides the first set of user-interface elements to the client computer 102, which displays the first set of user-interface elements using the web browser 116. Each user-interface element of the first set of user-interface elements can be associated with a particular gem attribute. A gem attribute refers to a particular property of a gem, and a value of the gem attribute refers to a particular instance of the gem attribute. Examples of gem attributes include carat weight, clarity, color, cut, length-to-width ratio, polish, price, shape, symmetry, and so forth. Desirably, the gem search module 126 employs gem attributes that are intuitively meaningful to the user to facilitate a search for gems. In some instances, the gem search module 126 can provide tutorials to enhance user understanding of various gem attributes.

To facilitate a search for gems, at least one user-interface element of the first set of user-interface elements represents a nonlinear scale of values of a gem attribute. For example, the first set of user-interface elements can include a sliding display element that represents a nonlinear scale of values of a gem attribute. A nonlinear scale of values refers to an arrangement of values, such that various intervals in the arrangement can be associated with varying differences in values. In some instances, a nonlinear scale of values can be envisioned as an axis of values in which a set of marks are placed at regularly spaced intervals along the axis and in which various intervals along the axis can be associated with varying differences in values. An example of a nonlinear scale of values is a logarithmic scale of values. Unlike a linear scale of values, a nonlinear scale of values of a gem attribute can be tailored to allow a greater or lesser variation of values of the gem attribute at various intervals in the nonlinear scale of values. For example, the nonlinear scale of values can be tailored to provide a greater or lesser variation of values of the gem attribute at a particular interval based on availability of gems at that interval, thus allowing a “sweet spot” to be created. Moreover, compared with a linear scale of values, a nonlinear scale of values of a gem attribute can allow a more compact representation of a range of values of the gem attribute. Such compact representation can be particularly desirable for gem attributes that can take on a wide range of values. For example, a nonlinear scale of values can be particularly desirable for gem attributes such as carat weight and price.

Using the first set of user-interface elements, a first set of values of various gem attributes can be specified by the user. In particular, the gem search module 126 receives a user specification of the first set of values and identifies a set of gems associated with the first set of values. For example, the gem search module 126 can provide a user-interface element that represents a number of values of a gem attribute. The gem search module 126 can receive a user selection of a particular value or a particular range of values of the gem attribute and can identify the set of gems as having the selected value or range of values of the gem attribute. In the illustrated embodiment, the gem search module 126 performs a search of the database 132 to identify the set of gems. Once the set of gems is identified, the gem search module 126 can indicate the set of gems and can allow the user to select a particular gem to be purchased.

Referring to FIG. 1, the gem setting search module 128 is configured to facilitate a search for gem settings. In particular, the gem setting search module 128 is used to search for a gem setting to be included in a jewelry item. For example, once a diamond has been selected, the gem setting search module 128 can be used to search for a diamond setting to be included with the diamond in a bracelet, a brooch, an earring, a pendant, a ring, or any other ornamental object. In some instances, the gem setting search module 128 can be used to search for a gem setting to be purchased as a stand-alone item.

In the illustrated embodiment, the gem setting search module 128 provides a second set of user-interface elements to facilitate a search for gem settings. The gem setting search module 128 provides the second set of user-interface elements to the client computer 102, which displays the second set of user-interface elements using the web browser 116. Each user-interface element of the second set of user-interface elements can be associated with a particular gem setting attribute. A gem setting attribute refers to a particular property of a gem setting, and a value of the gem setting attribute refers to a particular instance of the gem setting attribute. Examples of gem setting attributes include chain length, metal type, price, ring size, setting style, and so forth. Desirably, the gem setting search module 128 employs gem setting attributes that are intuitively meaningful to the user to facilitate a search for gem settings. In some instances, the gem setting search module 128 can provide tutorials to enhance user understanding of various gem setting attributes.

Using the second set of user-interface elements, a second set of values of various gem setting attributes can be specified by the user. In particular, the gem setting search module 128 receives a user specification of the second set of values and identifies a set of gem settings associated with the second set of values. For example, the gem setting search module 128 can provide a user-interface element that represents a number of values of a gem setting attribute. The gem setting search module 128 can receive a user selection of a particular value or a particular range of values of the gem setting attribute and can identify the set of gem settings as having the selected value or range of values of the gem setting attribute. In some instances, the gem setting search module 128 can identify the set of gem settings based on whether one or more gem settings of the set of gem settings match a gem that has been selected by the user. In the illustrated embodiment, the gem setting search module 128 performs a search of the database 132 to identify the set of gem settings. Once the set of gem settings is identified, the gem setting search module 128 can indicate the set of gem settings and can allow the user to select a particular gem setting to be purchased.

To facilitate a selection of a particular gem setting, the gem setting search module 128 provides a set of visual representations of the set of gem settings that are identified. In the illustrated embodiment, the gem setting search module 128 performs a search of the database 132 to retrieve the set of visual representations. The gem setting search module 128 then provides the set of visual representations to the client computer 102, which displays the set of visual representations using the web browser 116. For example, the set of visual representations can include visual representations of respective ones of the set of gem settings. Based on the visual representations, the user can visually compare different gem settings to select a particular gem setting. To provide the user with a sense of scale, the set of visual representations can include visual representations of respective ones of the set of gem settings along with a gem that has been selected by the user.

To facilitate further exploration of a particular gem setting, the set of visual representations can also include visual representations that correspond to different views of the gem setting. In some instances, the gem setting search module 128 can allow the user to select a particular view to be displayed, thus enhancing interactivity. Examples of views include those having different magnification factors, such as an initial view, an enlarged view, a reduced view, and so forth. Additional examples of views include those having different orientations, such as a perspective view, a side view, a top view, and so forth. Desirably, at least one of the visual representations can correspond to a particular view of the gem setting as being worn. In particular, such visual representation can correspond to a particular view of the gem setting as being worn on a human body part, such as an ear, a hand, a finger, a neck, and so forth. To provide the user with a sense of scale, such visual representation can correspond to a particular view of a jewelry item as being worn, which jewelry item includes the gem setting along with a gem that has been selected by the user.

Referring to FIG. 1, the purchase order module 130 is configured to facilitate purchase of jewelry items. In particular, the purchase order module 130 is used to purchase a jewelry item that includes a gem and a gem setting that have been selected by the user. For example, once a particular diamond and a particular ring band have been selected, the purchase order module 130 can be used to purchase a ring that includes the selected diamond and the selected ring band. In some instances, the purchase order module 130 can be used to purchase a gem or a gem setting as a stand-alone item.

In the illustrated embodiment, the purchase order module 130 provides a third set of user-interface elements to facilitate purchase of a jewelry item. The purchase order module 130 provides the third set of user-interface elements to the client computer 102, which displays the third set of user-interface elements using the web browser 116. The third set of user-interface elements can be used to specify various types of sales information, such as customer name, customer address, method of payment, credit card number, items to be purchased, quantity of items to be purchased, and so forth. Based on such sales information, the purchase order module 130 can identify and process a purchase order of the jewelry item. In the illustrated embodiment, the purchase order module 130 incorporates sales information in the database 132 in connection with processing of a purchase order.

While the various modules 126, 128, and 130 and the database 132 are illustrated as residing in the server computer 104, it should be recognized that such configuration is not required in all applications. For example, one or more of the various modules 126, 128, and 130 and the database 132 can reside in a separate server computer (not illustrated in FIG. 1) that is connected to the server computer 104. Alternatively, or in conjunction, one or more of the various modules 126, 128, and 130 and the database 132 can reside in the client computer 102. For example, one or more of the various modules 126, 128, and 130 and the database 132 can be downloaded to the client computer 102 in an encrypted or compressed format. In addition, while not illustrated in FIG. 1, a database management program can be provided to create the database 132 as well as to facilitate access to the database 132.

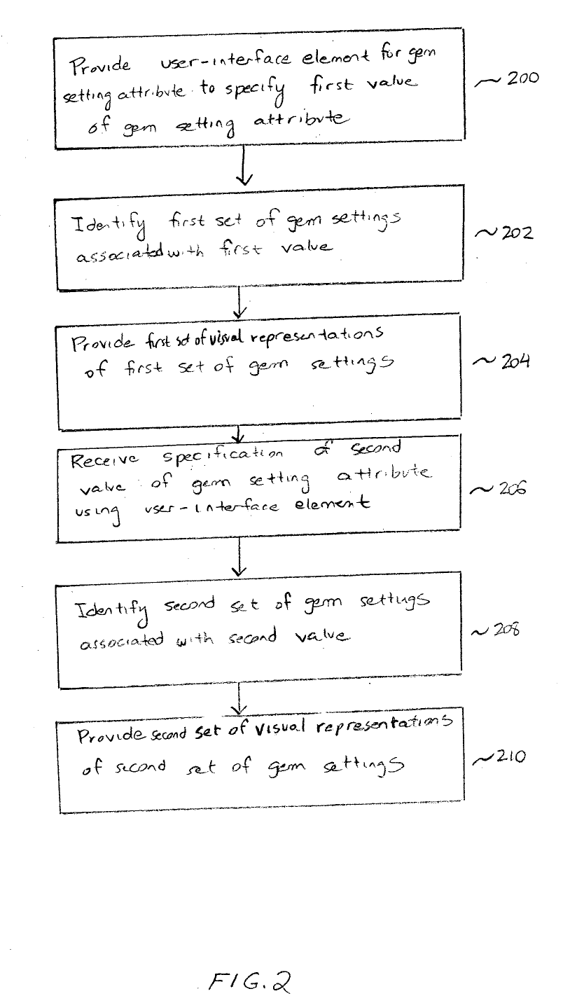

The foregoing provides an overview of an embodiment of the invention. Attention next turns to FIG. 2, which illustrates a flow chart for facilitating a search for gem settings, according to an embodiment of the invention.

The first operation illustrated in FIG. 2 is to provide a user-interface element for a gem setting attribute (block 200). In the illustrated embodiment, a gem setting search module (e.g., the gem setting search module 128) provides the user-interface element to facilitate a search for gem settings. In particular, the user-interface element represents a set of values of the gem setting attribute and is used to specify a first value included in the set of values.

As illustrated in FIG. 2, the second operation is to identify a first set of gem settings associated with the first value of the gem setting attribute (block 202). In the illustrated embodiment, the gem setting search module produces a first search query based on the first value and identifies the first set of gem settings as responsive to the first search query. As described previously, the gem setting search module can perform a search of a database (e.g., the database 132) to identify the first set of gem settings.

Referring to FIG. 2, the third operation is to provide a first set of visual representations of the first set of gem settings (block 204). In the illustrated embodiment, once the first set of gem settings are identified, the gem setting search module provides the first set of visual representations to facilitate a selection of a particular gem setting to be purchased. As described previously, the gem setting search module can perform a search of the database to retrieve the first set of visual representations.

For example, the first set of visual representations can include images of respective ones of the first set of gem settings. By viewing the images, a user can visually compare different gem settings to select a particular gem setting. To provide the user with a sense of scale, the images can be combined images of respective ones of the first set of gem settings along with a gem that has been selected by the user. In some instances, the gem setting search module can dynamically produce a combined image of a gem and a gem setting by superimposing an image of the gem onto an image of the gem setting or vice versa.

To facilitate further exploration of a particular gem setting, the first set of visual representations can also include images that correspond to different views of the gem setting. For example, in response to a user selection of a particular gem setting from the first set of gem settings, the gem setting search module can provide images that correspond to different views of the gem setting. In some instances, the gem setting search module can allow the user to select a particular view to be displayed, thus enhancing interactivity. Desirably, at least one of the images can correspond to a particular view of the gem setting as being worn on a human body part. For example, such image can be a combined image of the gem setting along with the human body part. To provide the user with a sense of scale and an overall view of a jewelry item as being worn, the combined image can also include an image of a gem that has been selected by the user. In some instances, the gem setting search module can dynamically produce the combined image of the gem, the gem setting, and the human body part by superimposing images of the gem, the gem setting, and the human body part, such as by superimposing a combined image of the gem and the gem setting onto an image of the human body part or vice versa. In a similar fashion as described above, the gem setting search module can provide images that correspond to different views of another gem setting that is selected from the first set of gem settings.

In some instances, the gem setting search module can provide information regarding a particular gem setting to allow the user to make an educated purchase of the gem setting. For example, in response to a user selection of a particular gem setting from the first set of gem settings, the gem setting search module can indicate values of various gem setting attributes for the gem setting. The gem setting search module can also provide information regarding various gem settings to allow a comparison of the gem settings. For example, the gem setting search module can indicate respective values of various gem setting attributes for the gem settings. In the illustrated embodiment, the gem setting search module can also allow fine tuning of a search for gem settings as described below.

As illustrated in FIG. 2, the fourth operation is to receive a user specification of a second value of the gem setting attribute (block 206). In the illustrated embodiment, the user-interface element is used to specify the second value included in the set of values.

The fifth operation illustrated in FIG. 2 is to identify a second set of gem settings associated with the second value of the gem setting attribute (block 208). In the illustrated embodiment, the gem setting search module produces a second search query based on the second value and identifies the second set of gem settings as responsive to the second search query. As described previously, the gem setting search module can perform a search of the database to identify the second set of gem settings.

Referring to FIG. 2, the sixth operation is to provide a second set of visual representations of the second set of gem settings (block 210). In the illustrated embodiment, once the second set of gem settings are identified, the gem setting search module provides the second set of visual representations to facilitate a selection of a particular gem setting to be purchased. As described previously, the gem setting search module can perform a search of the database to retrieve the second set of visual representations. In a similar fashion as described above, the second set of visual representations can include images of respective ones of the second set of gem settings. Also, to facilitate further exploration of a particular gem setting from the second set of gem settings, the second set of visual representations can also include images that correspond to different views of the gem setting. Desirably, at least one of the images can correspond to a particular view of the gem setting as being worn on a human body part. As described previously, the gem setting search module can provide information regarding various gem settings to allow a comparison of the gem settings and to allow the user to make an educated purchase of a particular gem setting. If desired, further fine tuning of a search for gem settings can be performed in a similar fashion as described above.

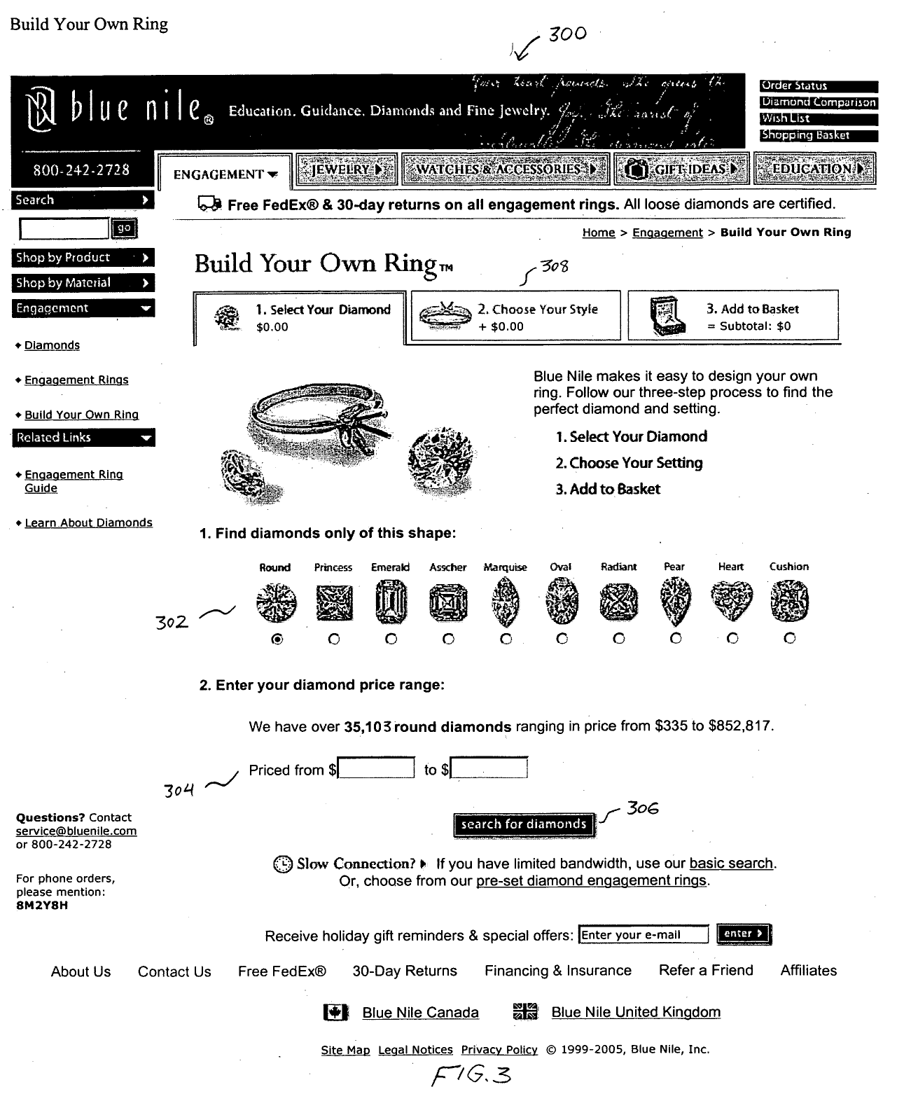

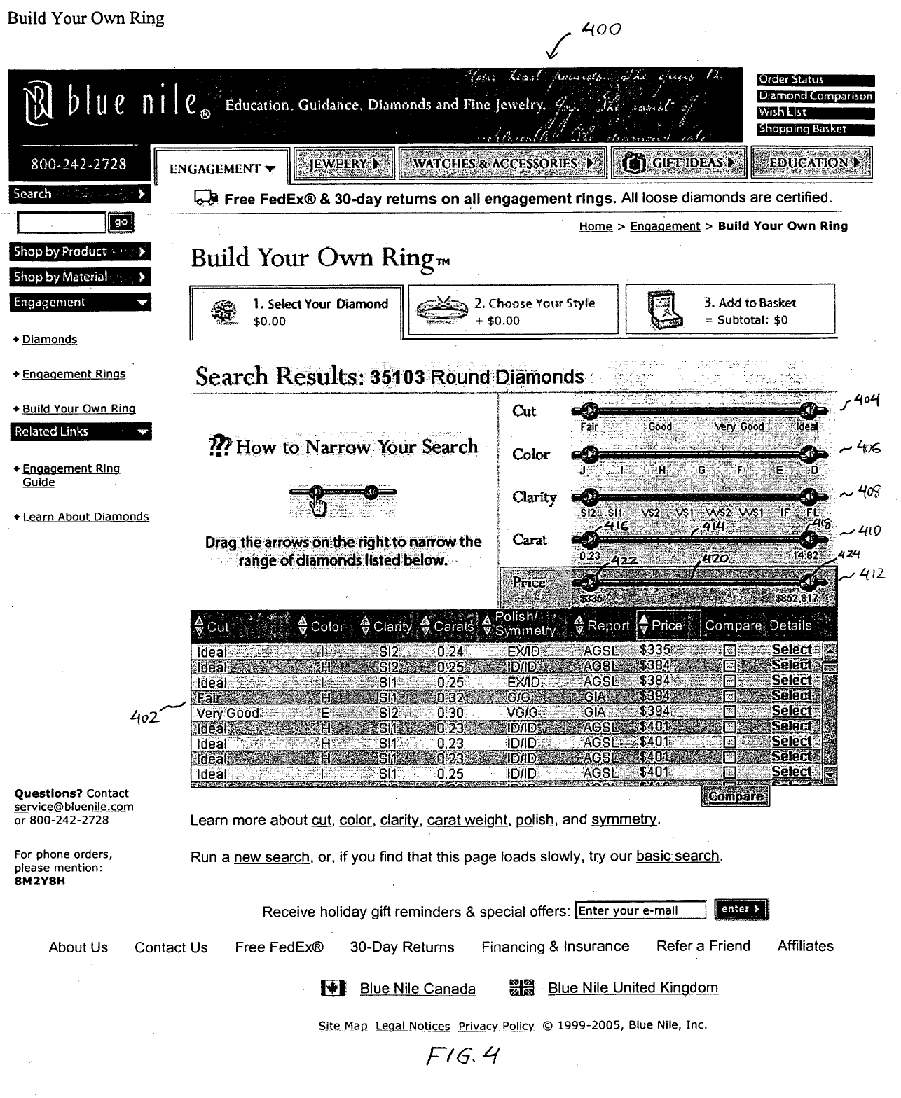

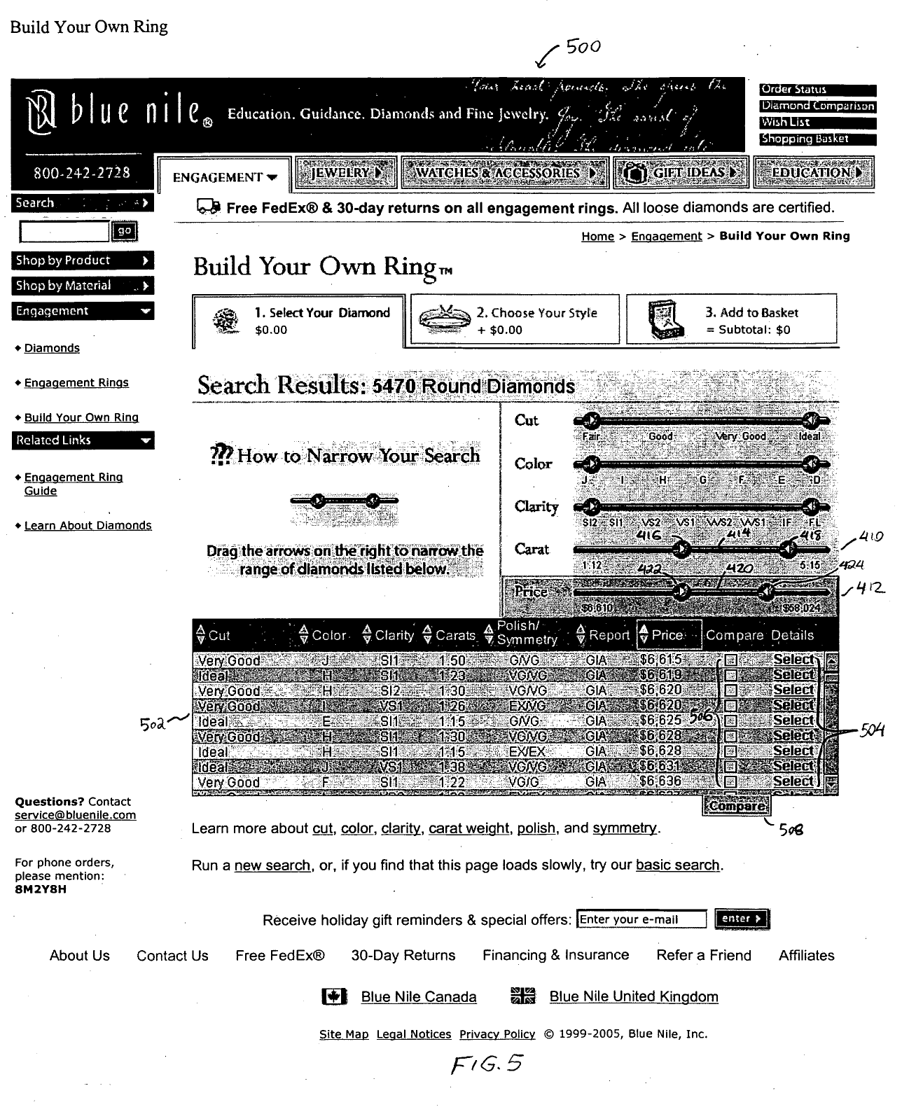

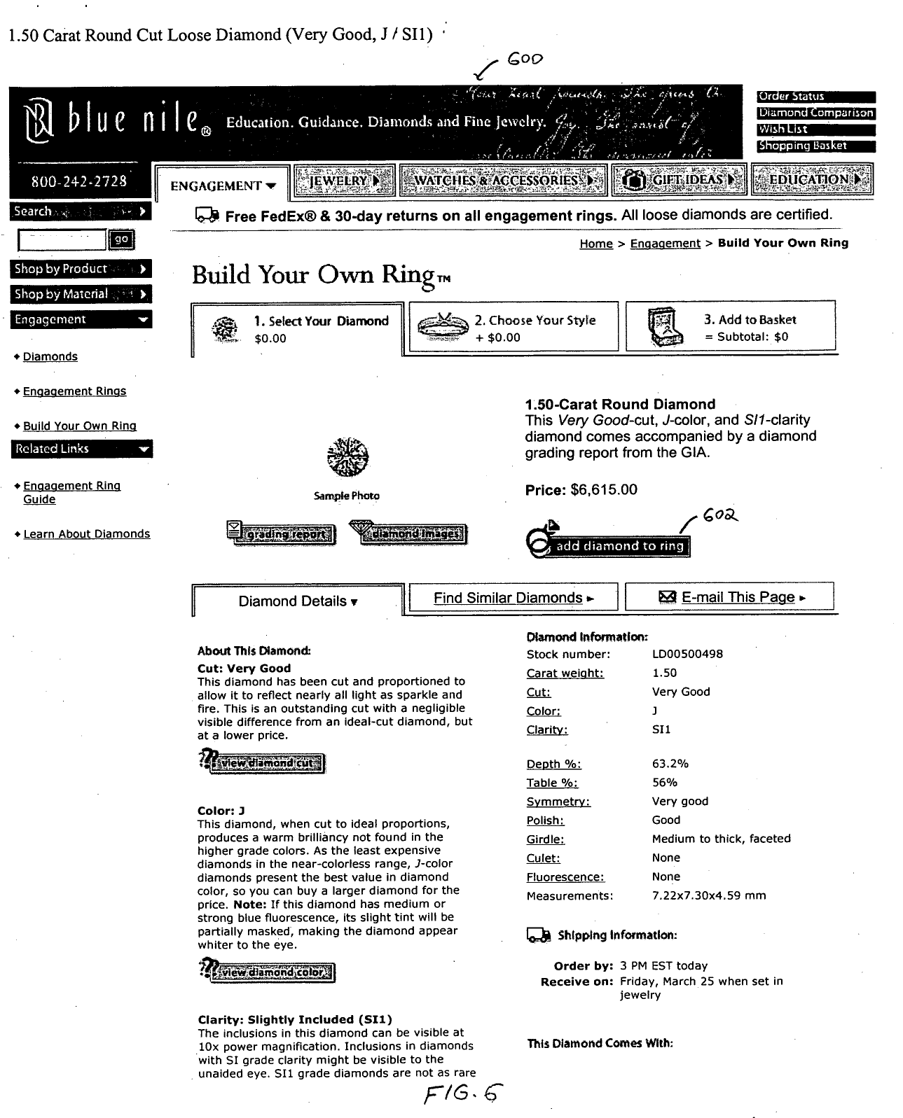

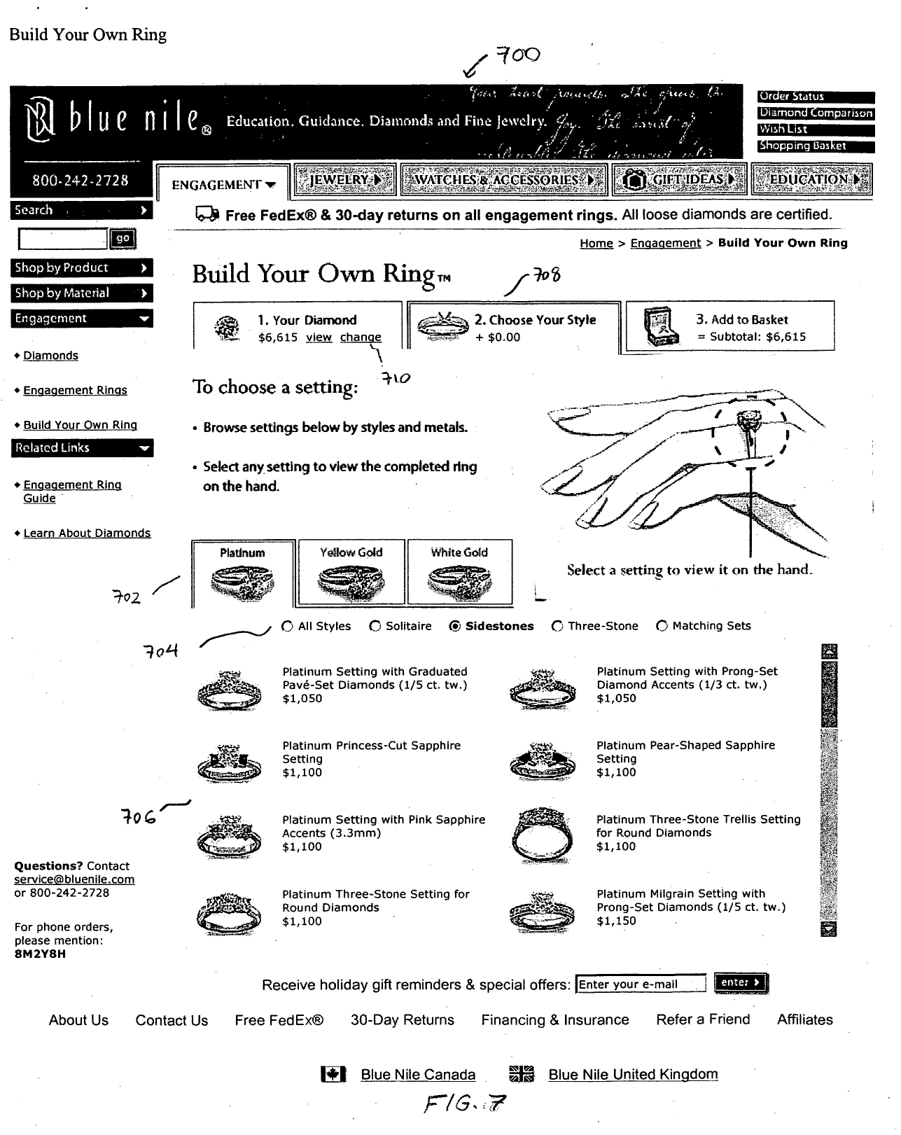

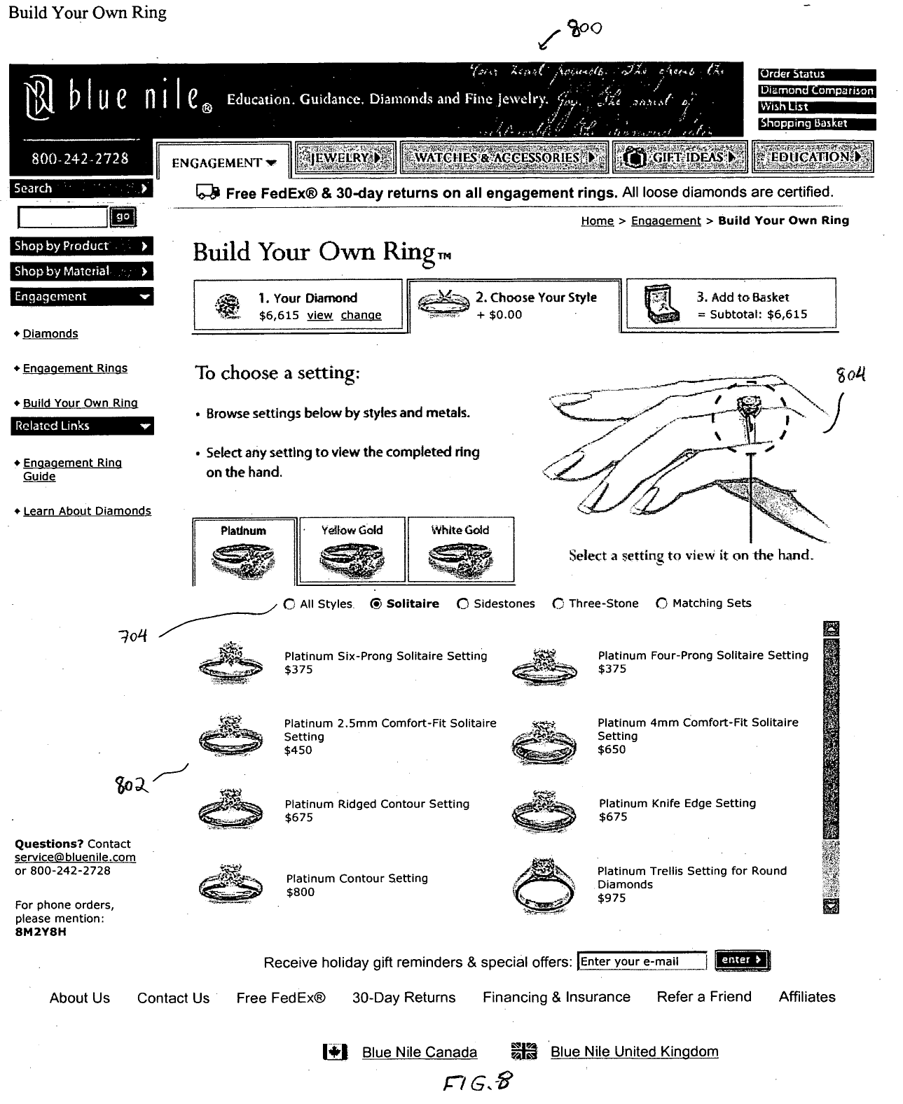

FIG. 3 through FIG. 12 illustrate examples of user-interface screens that can be provided according to an embodiment of the invention. In particular, FIG. 3 through FIG. 12 illustrate a sequence of user-interface screens to facilitate a search for a diamond and a ring band and to facilitate purchase of a ring that includes the diamond and the ring band. In the illustrated embodiment, the various user-interface screens can be provided as web pages that are displayed using a web browser (e.g., the web browser 116).

Attention first turns to FIG. 3, FIG. 4, FIG. 5, and FIG. 6, which illustrate examples of user-interface screens that can be provided by a gem search module (e.g., the gem search module 126). In particular, FIG. 3 illustrates a user-interface screen 300 to facilitate a search for a diamond to be included in a ring. As illustrated in FIG. 3, the user-interface screen 300 includes user-interface elements 302 and 304. The user-interface element 302 is provided as a set of radio buttons that allow a user to specify a particular shape of a diamond, such as round, princess, emerald, asscher, marquise, oval, radiant, pear, heart, or cushion. The user-interface element 304 is provided as a set of numeric entry fields that allow the user to specify a lower price limit and an upper price limit of a diamond. In the present example, a round shape is specified by, for example, a mouse click or a keyboard selection, and an option 306 labeled as “search for diamonds” is selected to search for diamonds having a round shape. As illustrated in FIG. 3, the user-interface screen 300 includes a status portion 308 that serves to indicate status information.

FIG. 4 illustrates a user-interface screen 400 indicating a set of diamonds that are identified. In the present example, 35,103 diamonds are identified as having a round shape. As illustrated in FIG. 4, various identified diamonds are indicated in a search results portion 402 of the user-interface screen 400. Here, the search results portion 402 also indicates respective values of various diamond attributes for the identified diamonds.

As illustrated in FIG. 4, the user-interface screen 400 includes user-interface elements 404, 406, 408, 410, and 412, which can be used to fine tune a search for diamonds. The user-interface element 404 allows the user to specify a range of values of a cut of a diamond. The cut of a diamond refers to the quality of processing that is used to shape the diamond and can be measured based on the diamond's roundness, depth, width, and uniformity of its facets. As illustrated in FIG. 4, the cut of a diamond can take on values that range from, for example, fair cut to ideal cut. The user-interface element 406 allows the user to specify a range of values of a color of a diamond. The color of a diamond refers to the ability of the diamond to reflect light of various wavelengths and can take on values that range from, for example, J (i.e., color slightly detectable) to D (i.e., no traces of color detectable by an expert gemologist). The user-interface element 408 allows the user to specify a range of values of a clarity of a diamond. The clarity of a diamond refers to the amount of trace minerals, fractures, or other imperfections present in the diamond and can take on values that range from, for example, SI2 (i.e., imperfections detectable under 10 times magnification and slightly detectable to unaided eye) to FL (i.e., no imperfections detectable under 10 times magnification). The user-interface element 410 allows the user to specify a range of values of a carat weight of a diamond, such as a range of values within 0.23 and 14.82 carats. And, the user-interface element 412 allows the user to specify a price range, such as a price range within $335 and $852,817.

In the present example, each of the user-interface elements 404, 406, 408, 410, and 412 is provided as a sliding display element that includes a bar and a pair of sliders. Each pair of sliders can be independently displaced to fine tune a search for diamonds. As illustrated in FIG. 4, the user-interface elements 404, 406, and 408 represent linear scales of values of the cut, color, and clarity of a diamond, respectively. The user-interface element 410 includes a bar 414, which represents a nonlinear scale of values of the carat weight of a diamond, and a pair of sliders 416 and 418. Either, or both, of the sliders 416 and 418 can be displaced by, for example, a click and drag operation to specify various ranges of values included in the nonlinear scale of values. The user-interface element 412 includes a bar 420, which represents a nonlinear scale of values of the price of a diamond, and a pair of sliders 422 and 424. Either, or both, of the sliders 422 and 424 can be displaced to specify various ranges of values included in the nonlinear scale of values.

Turning next to FIG. 5, a user-interface screen 500 is illustrated in which the sliders 416, 418, 422, and 424 are displaced relative to their original positions illustrated in FIG. 4. As illustrated in FIG. 5, the sliders 416 and 418 are displaced relative to the bar 414 to specify a lower carat weight limit of 1.12 carats and an upper carat weight limit of 5.15 carats. Also, the sliders 422 and 424 are displaced relative to the bar 420 to specify a lower price limit of $6,610 and an upper price limit of $58,024. In connection with the displacement of the sliders 416, 418, 422, and 424, a different set of diamonds having a round shape and having the specified ranges of carat weight and price are identified. This different set of diamonds can form a subset of the previously identified set of diamonds. In the present example, 5,470 diamonds are identified, and various identified diamonds are indicated in a search results portion 502 of the user-interface screen 500. Advantageously, the user-interface screen 500 provides enhanced interactivity by allowing the user to quickly see the impact that the displacement of the sliders 416, 418, 422, and 424 has on price and availability of diamonds. Moreover, such enhanced interactivity allows the user to easily make trade-offs in various diamond attributes to locate a desired diamond.

As illustrated in FIG. 5, the user-interface screen 500 includes a set of options 504 labeled as “select” that allow the user to select a particular diamond to be included in a ring. The user-interface screen 500 also includes a set of check boxes 506 that allow the user to select two or more diamonds for comparison purposes. Once two or more diamonds have been selected, an option 508 labeled as “compare” can be selected, and respective values of various diamond attributes for the selected diamonds can be indicated. Based on a comparison of two or more diamonds, the user can select a particular diamond to be included in a ring. FIG. 6 illustrates a user-interface screen 600 to facilitate a selection of a diamond to be included in a ring. In the present example, a 1.50-carat round diamond is selected using an option 602 labeled as “add diamond to ring.”

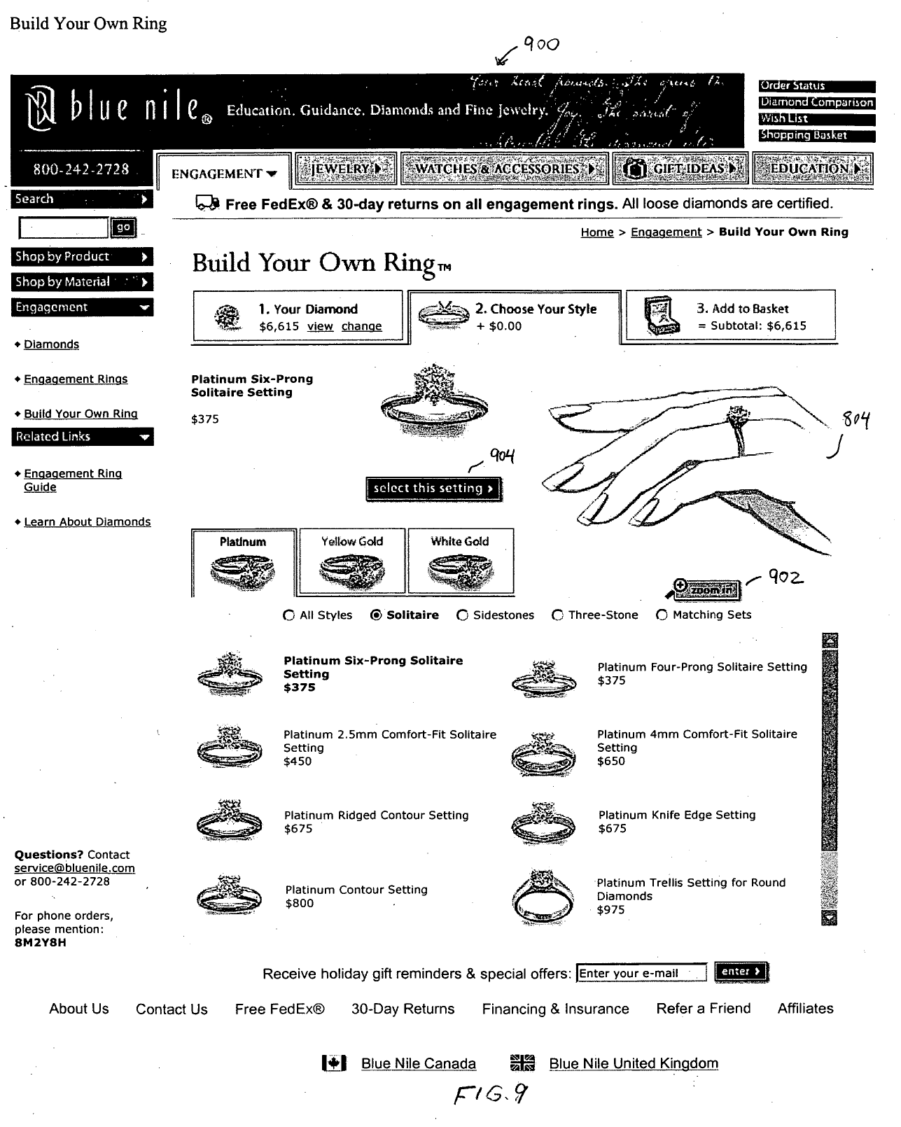

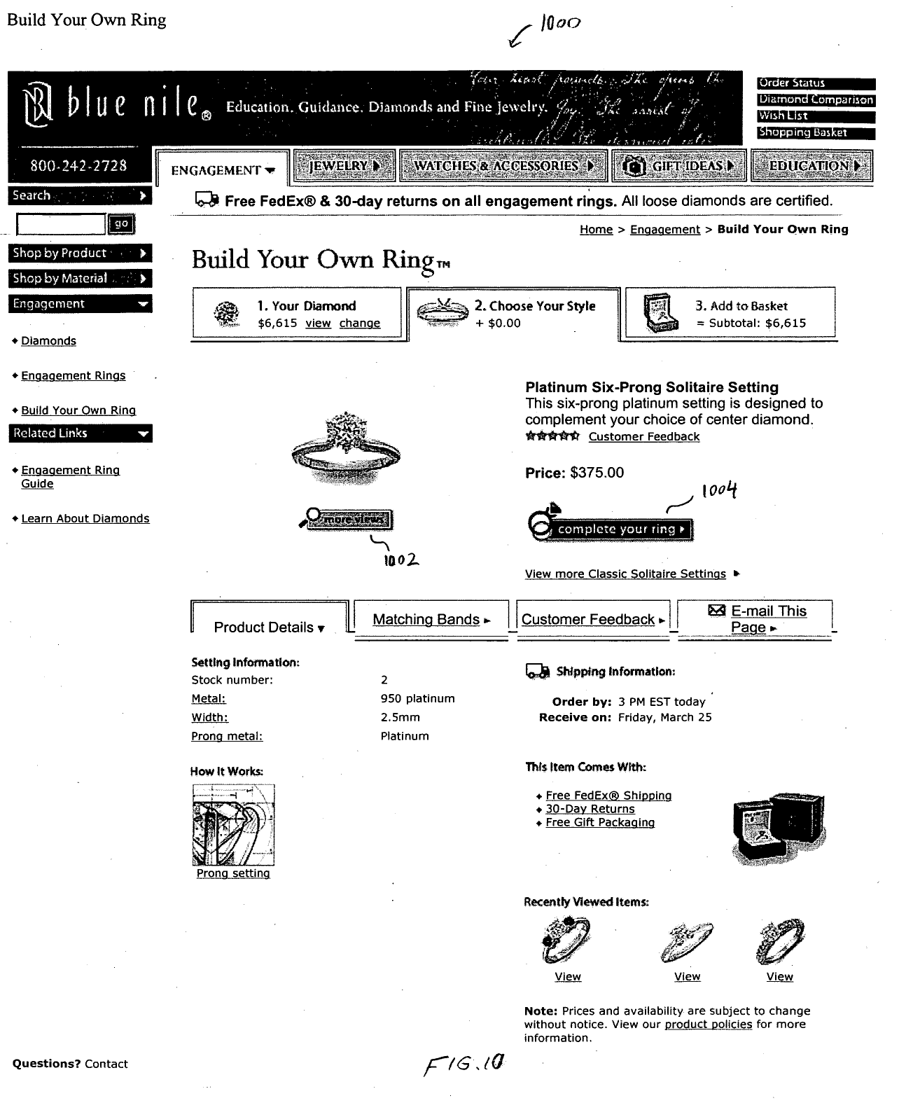

Turning next to FIG. 7, FIG. 8, FIG. 9, FIG. 10, and FIG. 11, various examples of user-interface screens that can be provided by a gem setting search module (e.g., the gem setting search module 128) are illustrated. In particular, FIG. 7 illustrates a user-interface screen 700 to facilitate a search for a ring band to be included in a ring. As illustrated in FIG. 7, the user-interface screen 700 includes user-interface elements 702 and 704. The user-interface element 702 is provided as a set of tabs that allow the user to specify a particular metal type of a ring band, such as platinum, silver, yellow gold, or white gold. The user-interface element 704 is provided as a set of radio buttons that allow the user to specify a particular setting style of a ring band, such as solitaire, sidestones, three-stones, or matching sets. In the present example, a platinum metal type and a sidestones setting style are specified by, for example, a mouse click or a keyboard selection, and a set of ring bands are identified.

As illustrated in FIG. 7, various identified ring bands are indicated in a search results portion 706 of the user-interface screen 700. Advantageously, the search results portion 706 provides images of respective ones of the identified ring bands along with a previously selected diamond, thus allowing the user to quickly see how different ring bands appear in combination with the previously selected diamond. Here, the search results portion 706 also indicates respective values of various ring band attributes for the identified ring bands. As illustrated in FIG. 7, the user-interface screen 700 includes a status portion 708 that indicates updated status information to reflect the previously selected diamond. The status portion 708 includes an option 710 labeled as “change,” which can be selected to search for a different diamond to be included in the ring.

Turning next to FIG. 8, a user-interface screen 800 is illustrated in which the user-interface element 704 is used to specify a different setting style of a ring band. As illustrated in FIG. 8, the user-interface element 704 is used to specify a solitaire setting style by, for example, a mouse click or a keyboard selection. In response, a different set of ring bands having a platinum metal type and a solitaire setting style are identified. In the present example, various identified ring bands are indicated in a search results portion 802 of the user-interface screen 800. Advantageously, the user-interface screen 800 provides enhanced interactivity by allowing the user to quickly see the impact that the displacement of the user-interface element 704 has on price and availability of ring bands. Moreover, such enhanced interactivity allows the user to easily make trade-offs in various ring band attributes to locate a desired ring band. Based on viewing the search results portion 802, the user can select a particular ring band to be further explored. In the present example, the user-interface screen 800 provides an image 804 of a ring as worn on a hand. As further described below, the image 804 is updated in response to a user selection of a particular ring band to be further explored.

FIG. 9 illustrates a user-interface screen 900 to facilitate further exploration of a particular ring band. In the present example, a platinum six-prong solitaire setting is selected by, for example, a mouse click or a keyboard selection, and the image 804 is updated to provide a side view of the platinum six-prong solitaire setting along with a previously selected diamond. Advantageously, the user-interface screen 900 provides enhanced interactivity by allowing the user to quickly see how the platinum six-prong solitaire setting and the previously selected diamond appear when worn. Moreover, by selecting another ring band, such enhanced interactivity allows the user to quickly see how different ring bands appear when worn. As illustrated in FIG. 9, the user-interface screen 900 includes an option 902 labeled as “zoom in,” which can be selected to provide an enlarged view of the platinum six-prong solitaire setting when worn. In the present example, the user-interface screen 900 also includes an option 904 labeled as “select this setting” that allows the user to select the platinum six-prong solitaire setting to be included in a ring.

FIG. 10 illustrates another user-interface screen 1000 to facilitate further exploration of a particular ring band. In the present example, the user-interface screen 1000 includes an option 1002 labeled as “more views,” which can be selected to provide additional views of a platinum six-prong solitaire setting. In particular, referring next to FIG. 11, a user-interface screen 1100 is illustrated that provides an image 1102 of the platinum six-prong solitaire setting as worn on a hand. Here, the image 1102 provides a top view of the platinum six-prong solitaire setting along with a previously selected diamond. As illustrated in FIG. 11, the user-interface screen 1100 includes a set of options 1104 that allow the user to specify a particular view of the platinum six-prong solitaire setting to be displayed. Turning back to FIG. 10, the user-interface screen 1000 also includes an option 1004 labeled as “complete your ring” that allows the user to select the previously selected diamond and the platinum six-prong solitaire setting to be included in a ring.

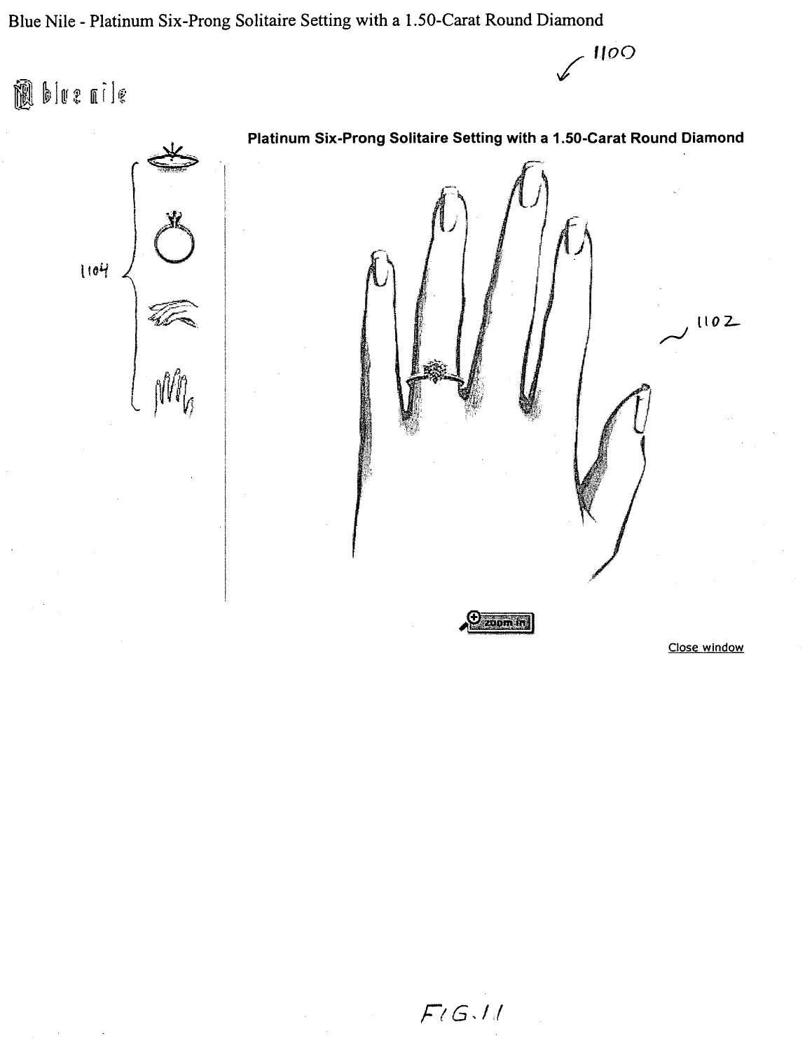

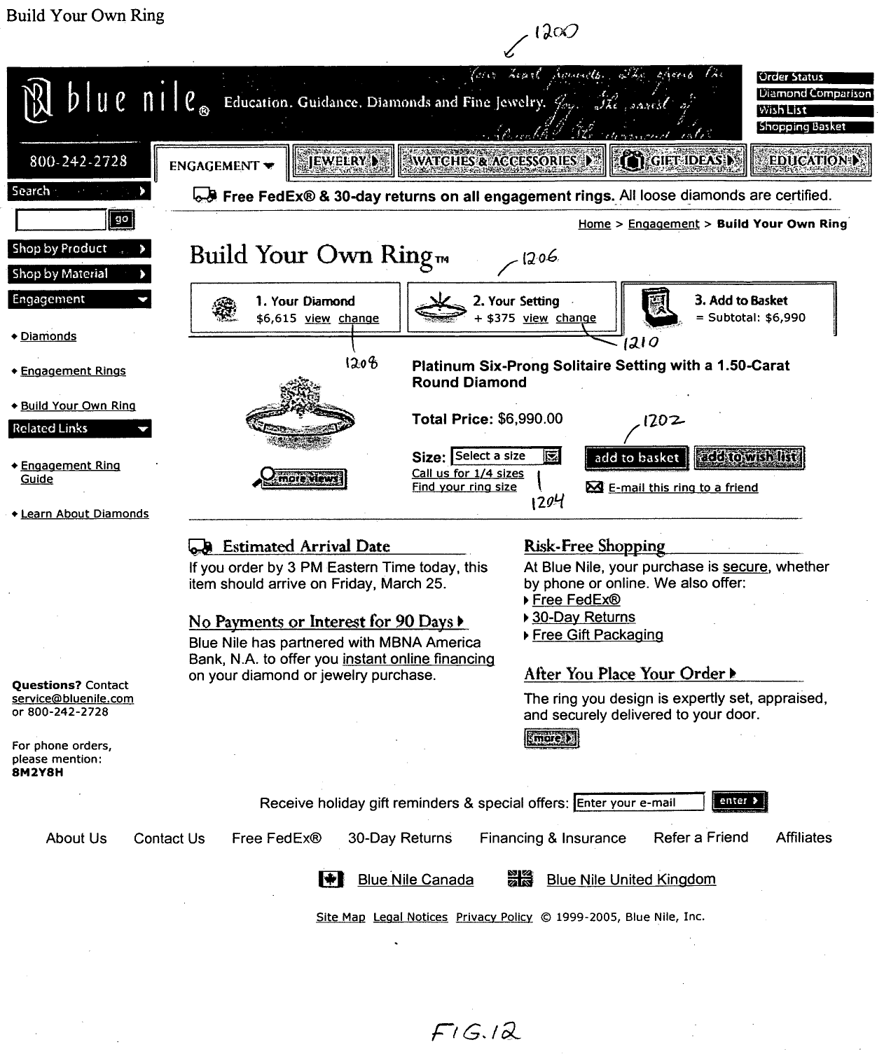

Once a diamond and a ring band have been selected, the user may desire to purchase a ring that includes the selected diamond and ring band. FIG. 12 illustrates a user-interface screen 1200 that can be provided by a purchase order module (e.g., the purchase order module 130). In the present example, a purchase order for the ring can be specified using an option 1202 labeled as “add to basket.” As illustrated in FIG. 12, the user-interface screen 1200 includes an user-interface element 1204, which is provided as a pull-down menu and allows the user to specify a ring size for the ring band. The user-interface screen 1200 also includes a status portion 1206 that indicates updated status information to reflect the selected diamond and ring band. The status portion 1206 includes options 1208 and 1210, which are labeled as “change” and can be selected to search for a different diamond or ring band to be included in the ring.

It should be recognized that the specific embodiments of the invention described above are provided by way of example, and various other embodiments are encompassed by the invention. According to some embodiments of the invention, a gem search module can provide a set of visual representations of a set of gems that are identified. For example, the set of visual representations can include images of respective ones of the set of gems. By viewing the images, a user can visually compare different gems to select a particular gem. Also, according to some embodiments of the invention, a gem setting search module can provide at least one user-interface element that represents a nonlinear scale of values of a gem setting attribute. For example, the user-interface element can be provided as a sliding display element that represents a logarithmic scale of values of the gem setting attribute.

An embodiment of the invention can include a help system, including a wizard that provides assistance to users for configuring a computer (e.g., the computer 102 or 104) and its various components.

An embodiment of the invention relates to a computer storage product with a computer-readable medium having executable instructions or computer code thereon for performing various computer-implemented operations. The term “computer-readable medium” is used herein to include any medium that is capable of storing or encoding a sequence of executable instructions or computer codes for performing the operations described herein. The media and computer code can be those specially designed and constructed for the purposes of the invention, or can be of the kind well known and available to those having skill in the computer software arts. Examples of computer-readable media include: magnetic media such as hard disks, floppy disks, and magnetic tape; optical media such as Compact Disc-Read Only Memories (“CD-ROMs”) and holographic devices; magneto-optical media such as floptical disks; and hardware devices that are specially configured to store and execute program code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as produced by a compiler, and files containing higher level code that are executed by a computer using an interpreter. For example, an embodiment of the invention may be implemented using Java, C++, or other object-oriented code, such as object-oriented programming language and development tools. Additional examples of computer code include encrypted code and compressed code. Also, certain embodiments of the invention may be implemented using client-side code or scripting languages, such as Dynamic Hypertext Markup Language (“DHTML”) or JavaScript.

Moreover, an embodiment of the invention can be downloaded as a computer program product, which can be transferred from a remote computer (e.g., a server computer) to a requesting computer (e.g., a client computer or a different server computer) by way of data signals embodied in a carrier wave or other propagation medium via a transmission channel. Accordingly, as used herein, a carrier wave can be regarded as a computer-readable medium.

Another embodiment of the invention can be implemented in hardwired circuitry in place of, or in combination with, computer code.

A practitioner of ordinary skill in the art requires no additional explanation in developing the apparatus and method described herein but may nevertheless find some helpful guidance by examining the patent application of Elowitz el al., U.S. patent application Ser. No. 10/452,789, entitled “Apparatus and Method for Facilitating a Search for Gems” and filed on May 30, 2003, the disclosure of which is incorporated herein by reference in its entirety.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit, and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

1. A computer-readable medium comprising:
a gem search module to facilitate a search for a gem to be included in a jewelry item, said gem search module being configured to provide a first user-interface element representing a first plurality of values of a gem attribute, said gem search module being configured to receive a selection of a first value from said first plurality of values and to identify said gem as being associated with said first value; and
a gem setting search module to facilitate a search for a gem setting to be included in said jewelry item, said gem setting search module being configured to provide a second user-interface element representing a second plurality of values of a gem setting attribute, said gem setting search module being configured to receive a selection of a second value from said second plurality of values and to identify said gem setting as being associated with said second value, said gem setting search module being configured to provide a visual representation of said jewelry item as being worn.

2. The computer-readable medium of claim 1, wherein said gem attribute corresponds to one of carat weight, clarity, color, cut, length-to-width ratio, polish, price, shape, and symmetry.

3. The computer-readable medium of claim 1, wherein said gem setting attribute corresponds to one of chain length, metal type, price, ring size, and setting style.

4. The computer-readable medium of claim 1, wherein said gem setting search module is configured to provide said visual representation based on superimposing an image of said gem and said gem setting onto an image of a body part.

5. The computer-readable medium of claim 1, wherein said visual representation corresponds to a first visual representation of said jewelry item as being worn, said gem setting search module being configured to provide a second visual representation of said jewelry item as being worn, said first visual representation and said second visual representation corresponding to different views of said jewelry item as being worn.

6. A computer-readable medium comprising executable instructions to:
facilitate creation of a first search query based on a first value of a gem setting attribute;
identify a first plurality of gem settings as being responsive to said first search query; and
in response to a selection of a first gem setting from said first plurality of gem settings, provide a first visual representation of said first gem setting as being worn.

7. The computer-readable medium of claim 6, wherein said executable instructions to facilitate creation of said first search query include executable instructions to provide a user-interface element representing a plurality of values of said gem setting attribute, said plurality of values including said first value.

8. The computer-readable medium of claim 6, wherein said gem setting attribute corresponds to metal type, and said first value corresponds to one of platinum, silver, yellow gold, and white gold.

9. The computer-readable medium of claim 6, wherein said gem setting attribute corresponds to setting style, and said first value corresponds to one of solitaire, sidestones, three-stone, and matching sets.

10. The computer-readable medium of claim 6, wherein said executable instructions to provide said first visual representation include executable instructions to provide a combined image of said first gem setting and a body part.

11. The computer-readable medium of claim 10, wherein said executable instructions to provide said combined image include executable instructions to superimpose an image of said first gem setting onto an image of said body part.

12. The computer-readable medium of claim 6, further comprising executable instructions to:
in response to a request for a different view of said first gem setting, provide a second visual representation of said first gem setting as being worn.

13. The computer-readable medium of claim 12, wherein said first visual representation and said second visual representation correspond to different ones of an initial view, an enlarged view, and a reduced view of said first gem setting as being worn.

14. The computer-readable medium of claim 12, wherein said first visual representation and said second visual representation corresponds to different ones of a perspective view, a side view, and a top view of said first gem setting as being worn.

15. The computer-readable medium of claim 6, further comprising executable instructions to:
in response to a selection of a second gem setting from said first plurality of gem settings, provide a second visual representation of said second gem setting as being worn.

16. The computer-readable medium of claim 6, further comprising executable instructions to:
facilitate creation of a second search query based on a second value of said gem setting attribute;
identify a second plurality of gem settings as being responsive to said second search query; and
in response to a selection of a second gem setting from said second plurality of gem settings, provide a second visual representation of said second gem setting as being worn.

17. A computer-implemented method of facilitating a search for gem settings, comprising:
identifying a first plurality of gem settings as being associated with a first value of a gem setting attribute; and
in response to a selection of a first gem setting from said first plurality of gem settings, providing a combined image of said first gem setting and a body part.

18. The computer-implemented method of claim 17, wherein said body part corresponds to a human hand.

19. The computer-implemented method of claim 18, wherein said providing said combined image includes superimposing an image of said gem setting onto an image of said human hand.

20. The computer-implemented method of claim 17, further comprising:
in response to a selection of a second gem setting from said first plurality of gem settings, providing a combined image of said second gem setting and said body part.

21. The computer-implemented method of claim 17, further comprising:
identifying a second plurality of gem settings as being associated with a second value of said gem setting attribute; and
in response to a selection of a second gem setting from said second plurality of gem settings, providing a combined image of said second gem setting and said body part.
